(19) United States
(12) Patent Application Publication
(10) Pub. No.: US 2019/0092159 A1
(43) Pub. Date: Mar. 28, 2019

(54) BUILT-IN SUPPORT PILLAR FOR A FUEL TANK

(71) Applicant: TOYOTA JIDOSHA KABUSHIKI KAISHA, Toyota-shi (JP)

(72) Inventors: Shinsuke AMANO, Okazaki-shi (JP); Yuuki NAGASE, Toyota-shi (JP); Tomoki TADA, Toyota-shi (JP)

(73) Assignee: TOYOTA JIDOSHA KABUSHIKI KAISHA, Toyota-shi (JP)

(21) Appl. No.: 16/117,896

(22) Filed: Aug. 30, 2018

(30) Foreign Application Priority Data
Sep. 25, 2017 (JP) 2017-183974

(51) Int. Cl. B60K 15/03; B60K 15/077

(52) U.S. Cl. CPC B60K 15/03; B60K 15/077; B60K 2015/03217; B60K 2015/03243; B60K 2015/0775

(57) ABSTRACT

A built-in support pillar for a fuel tank including: a support pillar main body that is configured to be disposed inside a box-shaped fuel tank, and that joins together mutually facing internal walls of the fuel tank; an engaging portion for positioning that is formed on an outer circumferential surface of the support pillar main body; and a bracket that is mounted on the support pillar main body, the bracket including an engaged portion configured to be engaged with the engaging portion, and a fixing portion to which a built-in component is fixed.

### CROSS-REFERENCE TO RELATED APPLICATION

This application is based on and claims priority under 35 USC 119 from Japanese Patent Application No. 2017-183974 filed on Sep. 25, 2017, the disclosure of which is incorporated by reference herein.

### BACKGROUND

### Technical Field

The present disclosure relates to a built-in support pillar for a fuel tank.

### Related Art

A structure in which a built-in support pillar is provided inside a fuel tank main body is disclosed in Japanese Patent Application Laid-Open (JP-A) No. 2017-115793. A sender gauge (i.e., a remaining-quantity detection sensor) that detects the remaining quantity of fuel is fixed to an outer circumferential surface of the built-in support pillar.

In the structure described in JP-A No. 2017-115793, deformation of the fuel tank caused by changes in the internal pressure thereof can be prevented by the built-in support pillar. Moreover, by fixing built-in components such as the remaining-quantity detection sensor and the like to the built-in support pillar, providing a dedicated component for mounting the remaining-quantity fuel sensor becomes unnecessary. However, in a structure in which a built-in component is fixed directly onto the built-in support pillar, the built-in component can only be fixed in a predetermined position. Consequently, in order to alter the position of a built-in component, it is necessary to alter the design of the built-in support pillar, and there is room for improvement in regard to making it easier to alter the position of a built-in component.

### SUMMARY

The present disclosure has been conceived in view of the above-described circumstances and provides a built-in support pillar for a fuel tank that enables the position of a built-in component inside a fuel tank to be altered easily.

A first aspect of the present disclosure is a built-in support pillar for a fuel tank including a support pillar main body that is configured to be disposed inside a box-shaped fuel tank, and that joins together mutually facing internal walls of the fuel tank; an engaging portion for positioning that is formed on an outer circumferential surface of the support pillar main body; and a bracket that is mounted on the support pillar main body, the bracket including an engaged portion configured to be engaged with the engaging portion, and a fixing portion to which a built-in component is fixed.

In the built-in support pillar for a fuel tank of the first aspect, the support pillar main body is provided inside the box-shaped fuel tank, and the mutually facing internal walls of the fuel tank are joined together by the support pillar main body. The bracket is mounted on the support pillar main body, and the fixing portion to which a built-in component is fixed is formed on the bracket. The engaging portion used for positioning is formed on the outer circumferential surface of the support pillar main body, and the engaged portion that is engaged with the engaging portion is formed on the bracket. Consequently, the bracket may be mounted on the support pillar main body after having been positioned. Furthermore, because a built-in component is fixed to the support pillar via the bracket, the fixing position of the built-in component may be altered simply by altering the position and configuration of the fixing portion of the bracket. In other words, the position of a built-in component may be altered without having to alter the design of the support pillar main body.

In this way, according to the first aspect, the position of a built-in component in a fuel tank may be easily altered.

In the first aspect, the engaging portion may include a pair of protruding portions or a pair of recessed portions that are formed on the outer circumferential surface of the support pillar main body, and the bracket may be mounted on the support pillar main body as a result of the engaged portion being engaged with the pair of protruding portions or the pair of recessed portions.

In the built-in support pillar for a fuel tank having the above-described structure, because the engaged portion of the bracket is positioned by being engaged with the pair of protruding portions or the pair of recessed portions, in an engaged state the bracket may be prevented from rotating around the protruding portions or recessed portions.

In this way, according to the above-described structure, accuracy when assembling the bracket may be improved.

In the first aspect, the fixing portion may be configured to fix a remaining-quantity detection sensor that detects a quantity of fuel remaining inside the fuel tank thereto.

In the built-in support pillar for a fuel tank having the above-described structure, the remaining quantity of fuel inside a fuel tank may be detected by a remaining-quantity detection sensor that is fixed to the fixing portion. Moreover, there is no need to provide a separate, dedicated component in order to fix the remaining-quantity detection sensor inside the fuel tank.

In this way, according to the above-described structure, the position of a remaining-quantity detection sensor may be altered easily without the design of the support pillar main body needing to be altered, and, additionally, there is no need to provide a separate, dedicated component in order to fix the remaining-quantity detection sensor.

In the first aspect, the fixing portion may be configured to fix a fuel suctioning unit that is connected to a pump and suctions fuel inside the fuel tank thereto.

In the built-in support pillar for a fuel tank having the above-described structure, as a result of a pump being operated, fuel inside the fuel tank may be suctioned by a fuel suctioning unit that is fixed to the fixing portion. Additionally, there is no need to provide a separate, dedicated component in order to fix the suctioning unit inside the fuel tank.

In this way, according to the above-described structure, the position where a fuel suctioning unit is fixed may be altered easily without the design of the support pillar main body needing to be altered, and, additionally, there is no need to provide a separate, dedicated component in order to fix the fuel suctioning unit.

In the first aspect, the bracket may include a first circular arc portion and a second circular arc portion that have a circular arc-shaped cross-section, and the bracket may be mounted on the support pillar main body as a result of the support pillar main body being sandwiched between the first circular arc portion and the second circular arc portion.

In the built-in support pillar for a fuel tank having the above-described structure, because the bracket is mounted by sandwiching the support pillar main body between the first circular arc portion and the second circular arc portion, the bracket may be securely mounted.

In this way, according to the above-described structure, the bracket mounting strength may be improved.

In the first aspect, the engaged portion may be formed on the first circular arc portion, and the second circular arc portion may include an urging portion that is configured to, in a state in which the first circular arc portion and the second circular arc portion have been mounted on the support pillar main body, urges the support pillar main body towards the first circular arc portion side.

In the built-in support pillar for a fuel tank having the above-described structure, when the bracket (i.e. the first circular arc portion and the second circular arc portion) has been mounted on the support pillar main body, the support pillar main body is urged towards the first circular arc portion side by an urging portion of the second circular arc portion.

In this way, according to the above-described structure, the bracket may be maintained in a good mounting state.

A second aspect of the present disclosure is a built-in support pillar for a fuel tank including a support pillar main body that joins together mutually facing internal walls of a box-shaped fuel tank; an engaging portion for positioning that is formed on an outer circumferential surface of the support pillar main body; and a bracket that is mounted on the support pillar main body, the bracket including an engaged portion configured to be engaged with the engaging portion, and a plate-shaped built-in component that is configured to suppress flow noise of fuel inside the fuel tank, the plate-shaped built-in component being integrally formed with the bracket.

In the built-in support pillar for a fuel tank of the second aspect, the support pillar main body is provided inside the box-shaped fuel tank, and the mutually facing internal walls of the fuel tank are joined together by the support pillar main body. Moreover, a bracket is mounted on the support pillar main body, and the plate-shaped built-in component is formed integrally with the bracket. As a result, because the built-in component is fixed via the bracket to the support pillar, the position and configuration of the built-in component may be altered simply by replacing the bracket.

In this way, according to the second aspect, the position of a built-in component in a fuel tank may be easily altered.

### BRIEF DESCRIPTION OF THE DRAWINGS

FIG. 1 is schematic side view illustrating an outline of the overall structure of a fuel tank of a first exemplary embodiment.

FIG. 2 is an enlarged perspective view illustrating a first built-in support pillar of the first exemplary embodiment.

FIG. 3 is an exploded perspective view of FIG. 2 illustrating the first built-in support pillar of the first exemplary embodiment.

FIG. 4 is a cross-sectional view illustrating a state across a line 3-3 in FIG. 2.

FIG. 5 is an enlarged perspective view illustrating a second built-in support pillar of the first exemplary embodiment.

FIG. 6 is an exploded perspective view of FIG. 5 illustrating the second built-in support pillar of the first exemplary embodiment.

FIG. 7 is a cross-sectional view corresponding to FIG. 4 illustrating a variant example of the first built-in support pillar of the first exemplary embodiment.

FIG. 8 is an exploded perspective view a built-in support pillar of a second exemplary embodiment.

### DETAILED DESCRIPTION

### First Exemplary Embodiment

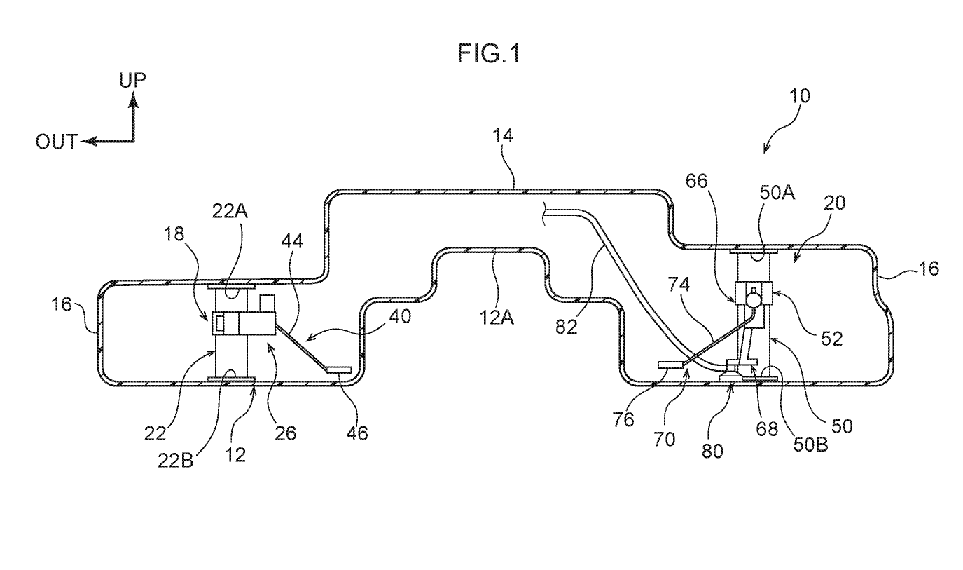

A fuel tank 10 in which a built-in support pillar (i.e., a first built-in support pillar 18 and a second built-in support pillar 20) according to a first exemplary embodiment has been applied will now be described with reference to the drawings. Note that an arrow UP and an arrow OUT depicted in FIG. 1 respectively indicate a vehicle upward direction and an outer side in a vehicle transverse direction when the fuel tank 10 is mounted in a vehicle. Hereinafter, unless specifically stated otherwise, if simple vertical or left-right directions are used, then these refer respectively to the vertical direction of a vehicle in which the fuel tank 10 is mounted, and the left and the right in the vehicle transverse direction when the vehicle is facing in the direction of forward travel.

[Overall Structure of a Fuel Tank]

As illustrated in FIG. 1, the fuel tank 10 is formed from resin in a box shape, and includes a bottom wall 12, a top wall 14 that is provided above the bottom wall 12 so as to face towards the bottom wall 12, and side walls 16 that join peripheral edges of the bottom wall 12 to peripheral edges of the top wall 14 in a vertical direction. Fuel is stored in the fuel tank 10. Note that, in FIG. 1, a state before fuel is stored is illustrated.

A protruding portion 12A that protrudes towards the vehicle upper side is provided at a central portion in the vehicle transverse direction of the bottom wall 12, and a space inside the fuel tank 10, apart from an upper end portion thereof, is partitioned in the vehicle transverse direction by the protruding portion 12A. In other words, the fuel tank 10 of the present exemplary embodiment is configured as a saddle-shaped fuel tank.

The first built-in support pillar 18 and the second built-in support pillar 20 are provided inside the fuel tank 10. The first built-in support pillar 18 is provided on one side in the vehicle transverse direction relative to the protruding portion 12A, while the second built-in support pillar 20 is provided on another side in the vehicle transverse direction relative to the protruding portion 12A.

[First Built-in Support Pillar]

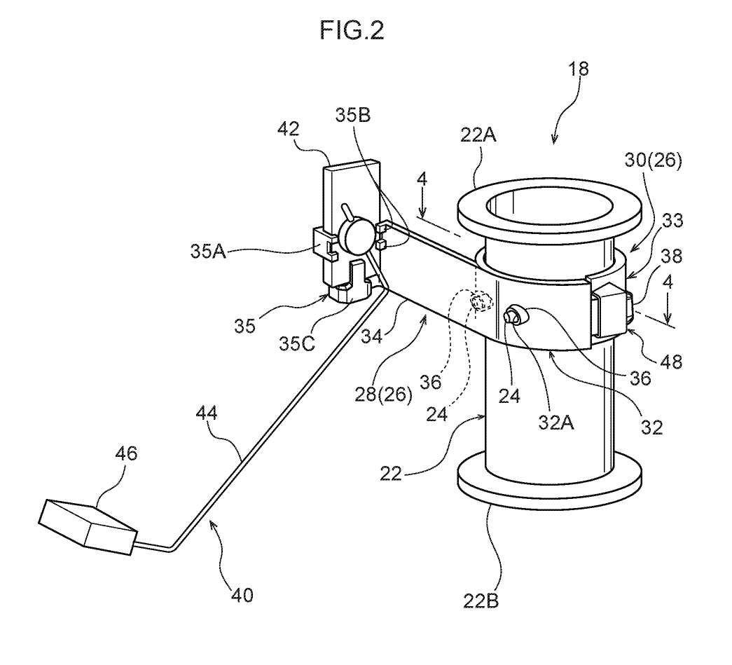

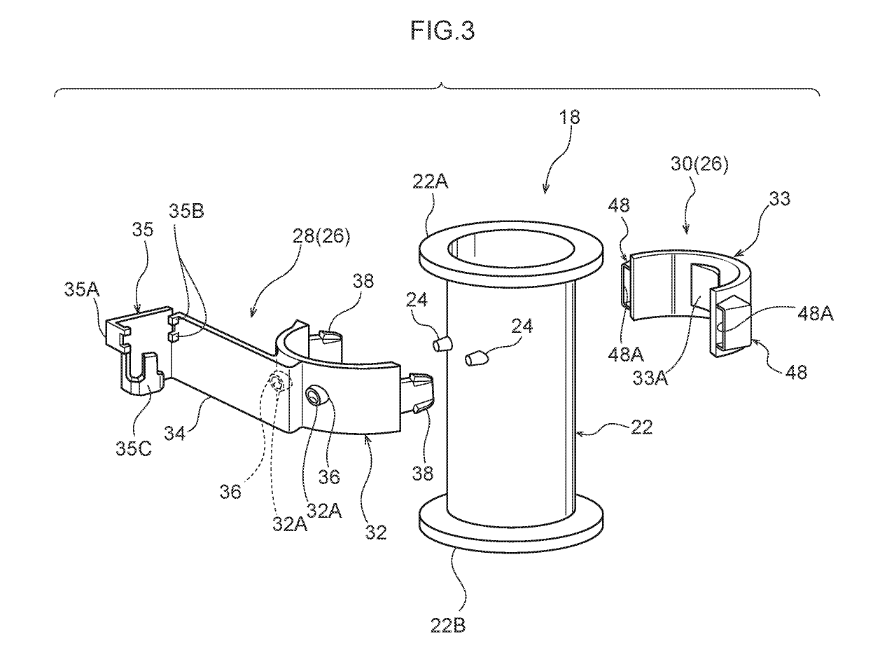

As illustrated in FIG. 2 and FIG. 3, the first built-in support pillar 18 includes a first support pillar main body 22 and a first bracket 26. The first support pillar main body 22 extends in the vehicle vertical direction and joins together the bottom wall 12 and the top wall 14 which are mutually facing inner walls of the fuel tank 10 (see FIG. 1).

The first support pillar main body 22 is formed in a substantially circular cylinder shape whose upper and lower end portions are open, and whose axial direction extends in the vertical direction. An upper flange 22A that extends outwards in a radial direction is provided at an upper end portion of the first support pillar main body 22. The upper flange 22A is welded to the top wall 14 of the fuel tank 10. A lower flange 22B that extends outwards in the radial direction is provided at a lower end portion of the first support pillar main body 22. The lower flange 22B is welded to the bottom wall 12 of the fuel tank 10.

A pair of protruding portions 24 serving as engaging portions which protrude from an outer circumferential surface of the first support pillar main body 22 are formed slightly above a central portion in the vertical direction of the first support pillar main body 22. The pair of protruding portions 24 are formed substantially in a circular column shape at a distance from each other in the circumferential direction of the first support pillar main body 22, and are formed in a tapered shape such that their diameter becomes gradually smaller approaching the distal end thereof.

The first bracket 26 is mounted on the first support pillar main body 22, as described above. As illustrated in FIG. 3, the first bracket 26 is a resin component that is formed so as to be mounted on the first support pillar main body 22 by sandwiching the first support pillar main body 22, and is separated into two halves in the form of a half component 28 and a half component 30.

The half component 28 includes a first circular arc portion 32, and a sensor fixing portion 35 that serves as a fixing portion. The first circular arc portion 32 is formed having a substantially circular arc-shaped cross-section so as to cover the outer circumferential surface of the first support pillar main body 22 on the side thereof where the protruding portions 24 are formed. Through holes 32A serving as engaged portions that correspond to the pair of protruding portions 24 are formed in the first circular arc portion 32. A pair of the through holes 32A are formed penetrating the first circular arc portion 32 in the thickness direction thereof, and guide walls 36 protrude towards the outer side of the first circular arc portion 32 from hole edges of the respective through holes 32A.

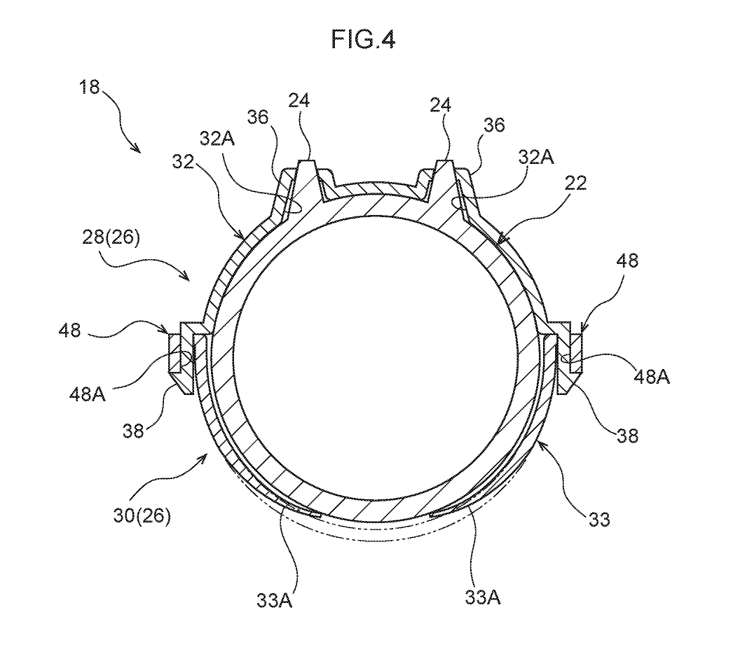

Furthermore, claw portions 38 extend towards a second circular arc portion 33 (described below) from both end portions of the first circular arc portion 32. Distal end portions of the claw portions 38 are formed having a larger width than base end portions thereof, and by inserting these distal end portions into through holes 48A that are formed in insertion portions 48 of the second circular arc portion 33 (described below), the first circular arc portion 32 is attached to the second circular arc portion 33 (see FIG. 4).

A flat plate-shaped extending portion 34 extends in a tangential direction of the first circular arc portion 32 from a portion of the first circular arc portion 32 located between the pair of through holes 32A. A distal end of the extending portion 34 is bent, and the bent portion forms the sensor fixing portion 35. Left-right guide portions 35A and 35B and a lower guide portion 35C that are used to fix the remaining-quantity detection sensor 40, which is an example of a built-in component, are formed on the sensor fixing portion 35.

The left-right guide portion 35A is formed by folding over a distal end portion of the sensor fixing portion 35, and two claws are formed at the distal end of the left-right guide portion 35A. In contrast, the left-right guide portion 35B is formed by two claws that extend from a base end portion of the sensor fixing portion 35 opposite the left-right guide portion 35A. The lower guide portion 35C is formed by folding over a lower end portion of the sensor fixing portion 35. The remaining-quantity detection sensor 40 is fixed in place using the left-right guide portions 35A and 35B, and the lower guide portion 35C.

As illustrated in FIG. 2, the remaining-quantity detection sensor 40 includes a base portion 42, an arm 44, and a float 46. The base portion 42 is formed substantially in a rectangular shape, and while superimposed with the sensor fixing portion 35, is fixed by the left-right guide portions 35A and 35B and the lower guide portion 35C such that it may not inadvertently come loose. The rod-shaped arm 44 extends downwards from the base portion 42, and a base end side of the arm 44 is rotatably connected to the base portion 42. The float 46, which floats on top of the fuel, is attached to a distal end side of the arm 44. In the remaining-quantity detection sensor 40, as a result of the height of the float 46 changing in accordance with the liquid level of the fuel, the rotation angle of the arm 44 relative to the base portion 42 also changes. The remaining quantity of fuel is detected by detecting this rotation angle.

As illustrated in FIG. 3, the half component 30 includes the second circular arc portion 33. The second circular arc portion 33 is formed having a substantially circular arc-shaped cross-section so as to cover the outer circumferential surface of the first support pillar main body 22 on the opposite side from the first circular arc portion 32. The insertion portions 48 are provided on the outer circumferential surface of both end portions of the second circular arc portion 33.

The through holes 48A are formed in each of the insertion portions 48, and the claw portions 38 of the first circular arc portion 32 are inserted through these through holes 48A. The first circular arc portion 32 is attached to the second circular arc portion 33 by the claw portions 38 being inserted through the insertion portions 48 and being anchored therein.

Pressing pieces 33A are formed on the second circular arc portion 33 as urging portions. As illustrated in FIG. 4, a pair of left and right pressing pieces 33A are formed, and extend respectively in a cantilever arrangement from the second circular arc portion 33. Distal end portions of the pressing pieces 33A are positioned on the inner side (i.e., on the first support pillar main body 22 side) of the main portion of the second circular arc portion 33. Consequently, a structure is created in which, when the first support pillar main body 22 is sandwiched between the first circular arc portion 32 and the second circular arc portion 33, the pressing pieces 33A urge the first support pillar main body 22 towards the first circular arc portion 32 side.

[Second Built-in Support Pillar]

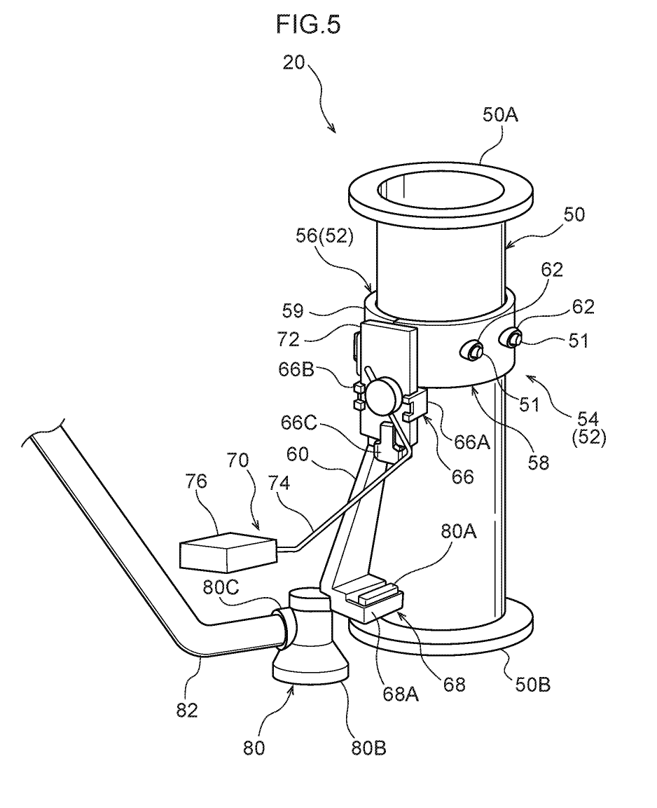

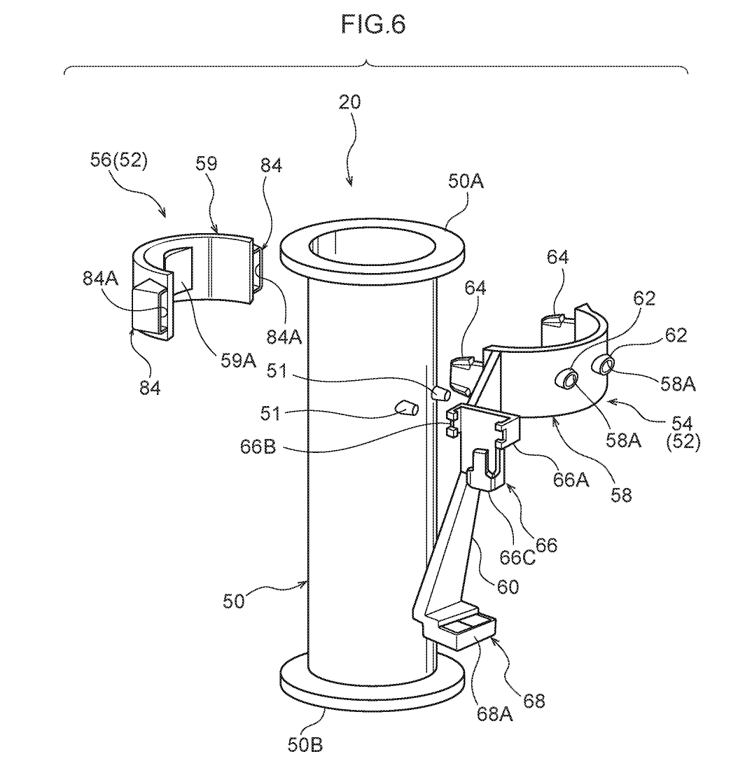

As illustrated in FIG. 5 and FIG. 6, the second built-in support pillar 20 includes a second support pillar main body 50 and a second bracket 52. The second support pillar main body 50 extends in the vehicle vertical direction and joins together the bottom wall 12 and the top wall 14 which are mutually facing inner walls of the fuel tank 10 (see FIG. 1).

The second support pillar main body 50 is formed in a substantially circular cylinder shape whose upper and lower end portions are open, and whose axial direction extends in the vertical direction. An upper flange 50A that extends outwards in the radial direction is provided at an upper end portion of the second support pillar main body 50. The upper flange 50A is welded to the top wall 14 of the fuel tank 10. A lower flange 50B that extends outwards in the radial direction is provided at a lower end portion of the second support pillar main body 50. The lower flange 50B is welded to the bottom wall 12 of the fuel tank 10.

A pair of protruding portions 51 serving as engaging portions, which protrude from an outer circumferential surface of the second support pillar main body 50, are formed slightly above a central portion in the vertical direction of the second support pillar main body 50. The pair of protruding portions 51 are formed substantially in a circular column shape at a distance from each other in the circumferential direction of the second support pillar main body 50, and are formed in a tapered shape such that their diameter becomes gradually smaller approaching the distal end thereof.

As described above, the second bracket 52 is mounted on the second support pillar main body 50. As illustrated in FIG. 6, the second bracket 52 is a resin component that is formed so as to be mounted on the second support pillar main body 50 by sandwiching the second support pillar main body 50, and is separated into two halves in the form of a half component 54 and a half component 56.

The half component 54 includes a first circular arc portion 58, and a sensor fixing portion 66 and pipe distal end fixing portion 68 that serve as fixing portions. The first circular arc portion 58 is formed having a substantially circular arc-shaped cross-section so as to cover the outer circumferential surface of the second support pillar main body 50 on the side thereof where the protruding portions 51 are formed. Through holes 58A serving as engaged portions that correspond to the pair of protruding portions 51 are formed in the first circular arc portion 58. The through holes 58A are formed penetrating the first circular arc portion 58 in the thickness direction thereof, and guide walls 62 protrude towards the outer side of the first circular arc portion 58 from hole edges of the respective through holes 58A.

Furthermore, claw portions 64 extend towards a second circular arc portion 59 (described below) from both end portions of the first circular arc portion 58. Distal end portions of the claw portions 64 are formed having a larger width than base end portions thereof, and by inserting these distal end portions into through holes 84A that are formed in insertion portions 84 of the second circular arc portion 59 (described below), the first circular arc portion 58 is attached to the second circular arc portion 59.

An extending portion 60 extends towards the lower side from one end portion of the first circular arc portion 58. A distal end of the extending portion 60 is located in the vicinity of the lower end portion of the second support pillar main body 50, and the sensor fixing portion 66 is formed slightly above a central portion in the vertical direction of the extending portion 60. Left-right guide portions 66A and 66B and a lower guide portion 66C that are used to fix a remaining-quantity detection sensor 70, which is serving as a built-in component, are formed on the sensor fixing portion 66.

The left-right guide portion 66A is formed by folding over a positioning end portion of the sensor fixing portion 66, and two claws are formed at a distal end of the left-right guide portion 66A. In contrast, the left-right guide portion 66B is formed by folding over another end portion of the sensor fixing portion 66 opposite the left-right guide portion 66A, and two claws are formed at a distal end of the left-right guide portion 66B. The lower guide portion 66C is formed by folding over a lower end portion of the sensor fixing portion 66. The remaining-quantity detection sensor 70 is fixed in place using the left-right guide portions 66A and 66B and the lower guide portion 66C.

As illustrated in FIG. 5, the remaining-quantity detection sensor 70 has a similar configuration to the remaining-quantity detection sensor 40, and includes a base portion 72, an arm 74, and a float 76. As a result of the height of the float 76 changing in accordance with the liquid level of the fuel, the rotation angle of the arm 74 relative to the base portion 72 also changes. The remaining quantity of fuel is detected by detecting this rotation angle.

As illustrated in FIG. 6, the pipe distal end fixing portion 68 is formed at the lower end portion of the extending portion 60. A frame-shaped insertion portion 68A is formed on the pipe distal end fixing portion 68. As illustrated in FIG. 5, an attachment piece 80A of a fuel suctioning unit 80 that is serving as a built-in component is inserted into the inner side of the insertion portion 68A.

The fuel suctioning unit 80 is formed in a substantially cylindrical shape having an open lower end side, and the attachment piece 80A extends from an upper end portion of the fuel suctioning unit 80. The attachment piece 80A is inserted into an inner side of the insertion portion 68A of the pipe distal end fixing portion 68, and by anchoring the attachment piece 80A in the insertion portion 68A, the fuel suctioning unit 80 is fixed to the pipe distal end fixing portion 68.

The lower end portion of the fuel suctioning unit 80 is formed as a large diameter portion 80B having diameter larger than that of the upper end side thereof, and plural suction holes (not illustrated in the drawings) that communicate with an interior space inside the fuel suctioning unit 80 are formed in an outer circumferential surface of the large diameter portion 80B. A substantially circular cylinder-shaped connecting portion 80C is formed between the large diameter portion 80B and the attachment piece 80A in the fuel suctioning unit 80, and a pipe 82 is connected to the connecting piece 80C. As a consequence, the internal space inside the fuel suctioning unit 80 communicates with a flow path inside the pipe 82.

As illustrated in FIG. 1, the pipe 82 extends to the opposite side of the space that is partitioned by the protruding portion 12A of the fuel tank 10, and is connected to a pump unit (not illustrated in the drawings) provided in this opposite side space. By operating this pump unit, fuel is suctioned from the fuel suctioning unit 80, and the fuel then passes through the pipe 82 and is transferred to the opposite side space.

As illustrated in FIG. 6, the half component 56 includes the second circular arc portion 59. The second circular arc portion 59 is formed having a substantially circular arc-shaped cross-section so as to cover the outer circumferential surface of the first support pillar main body 22 on the opposite side from the first circular arc portion 32. The insertion portions 84 are provided on the outer circumferential surface of both end portions of the second circular arc portion 59.

The through holes 84A are formed in each of the insertion portions 84, and the claw portions 64 of the first circular arc portion 58 are inserted through these through holes 84A. The first circular arc portion 58 is attached to the second circular arc portion 59 by the claw portions 64 being inserted through the insertion portions 84 and being anchored therein.

Pressing pieces 59A are formed on the second circular arc portion 59 as urging portions. A pair of left and right pressing pieces 59A are formed, and extend respectively in a cantilever arrangement from the second circular arc portion 59. Distal end portions of the pressing pieces 59A are positioned on the inner side (i.e., on the second support pillar main body 50 side) of the main portion of the second circular arc portion 59. Consequently, a structure is created in which, when the second support pillar main body 50 is sandwiched between the first circular arc portion 58 and the second circular arc portion 59, the pressing pieces 59A urge the second support pillar main body 50 towards the first circular arc portion 58 side.

[Operation and Effects]

Next, an operation and effects of the first exemplary embodiment will be described.

As illustrated in FIG. 1, in the fuel tank 10 of the first exemplary embodiment, the bottom wall 12 and the top wall 14 of the fuel tank 10 are joined together by the first built-in support pillar 18 and the second built-in support pillar 20. As a consequence, deformation of the fuel tank 10 caused by changes in the internal pressure thereof may be prevented.

Furthermore, as illustrated in FIG. 4, the first built-in support pillar 18 is provided with the first support pillar main body 22, and the first bracket 26 is mounted on the first support pillar main body 22. Here, the protruding portions 24 that are used for positioning are formed on the outer circumferential surface of the first support pillar main body 22, and the through holes 32A that are engaged with the protrusion portions 24 are formed in the first bracket 26. As a result, the first bracket 26 may be mounted on the first support pillar main body 22 after being placed in the correct position.

In particular, in the first exemplary embodiment, a pair of the protruding portions 24 are provided, and the through holes 32A formed in the first circular arc portion 32 of the first bracket 26 are positioned by being engaged with the pair of protruding portions 24. As a result, the first circular arc portion 32 may be prevented from rotating in a state in which the through holes 32A are engaged with the protruding portions 24. In other words, if only one protruding portion 24 is provided, then in a state in which the through hole 32A in the first circular arc portion 32 is engaged with the protruding portion 24, it is conceivable that the first circular arc portion 32 might rotate around the protruding portion 24. In contrast, in a structure such as that of the present exemplary embodiment in which a pair of protruding portions 24 are provided, and the pair of protruding portions 24 are engaged with the through holes 32A, any rotation of the first circular arc portion 32 is effectively prevented.

Furthermore, because the protruding portions 24 are formed in a tapered shape, compared with a structure in which the protruding portions 24 are formed in a circular column shape having a uniform diameter, the first circular arc portion 32 (i.e., the first bracket 26) may be mounted easily, and may be precisely positioned. Moreover, as illustrated in FIG. 2, because the remaining-quantity detection sensor 40, which is a built-in component, is fixed to the sensor fixing portion 35 of the first bracket 26, the fixing position of the remaining-quantity detection sensor 40 may be altered simply by altering the position and configuration of the sensor fixing portion 35 of the first bracket 26. In other words, the position of the remaining-quantity detection sensor 40 may be altered without having to alter the design of the first support pillar main body 22, so that there is a greater degree of freedom when designing the fuel tank 10. Additionally, there is no need to provide a separate, dedicated component in order to fix the remaining-quantity detection sensor 40 inside the fuel tank 10.

Furthermore, in the first exemplary embodiment, as illustrated in FIG. 5, the pipe distal end fixing portion 68 is provided on the second bracket 52, and the fuel suctioning unit 80 is fixed to the pipe distal end fixing portion 68. As a result, there is no need to provide a separate, dedicated component in order to fix the fuel suctioning unit 80 inside the fuel tank 10. In other words, the position of the fuel suctioning unit 80 may be altered without the design of the second support pillar main body 50 also having to be altered.

Furthermore, in the first exemplary embodiment, as illustrated in FIG. 4, the first bracket 26 is mounted by sandwiching the first support pillar main body 22 between the first circular arc portion 32 and the second circular arc portion 33. As a result, compared with a structure in which the bracket is mounted on the first support pillar main body 22 from only one side, the first bracket 26 may be mounted more securely. In other words, the mounting strength of the first bracket 26 may be improved.

Additionally, in the first exemplary embodiment, in a state in which the first bracket 26 has been mounted on the first support pillar main body 22, the first support pillar main body 22 may be urged towards the first circular arc portion 32 side by the pressing pieces 33A of the second circular arc portion 33. As a result, the first bracket 26 may be maintained in an excellent mounting state.

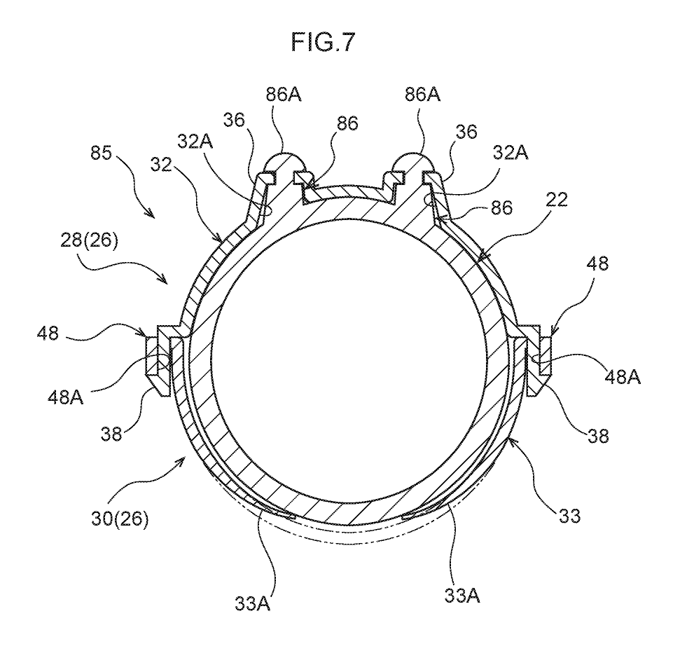

Note that, in the first exemplary embodiment, positioning is achieved by inserting the protruding portions 24 of the first support pillar main body 22 into the through holes 32A in the first circular arc portion 32, however, the present disclosure is not limited to this. For example, is it also possible to employ the structure of a variant example illustrated in FIG. 7.

### Variant Example

As illustrated in FIG. 7, in a first built-in support pillar 85 according to the variant example, a pair of protruding portions 86 are formed on the outer circumferential surface of the first support pillar main body 22. Each of the protruding portions 86 is formed longer in the direction of protrusion than the protruding portions 24 illustrated in FIG. 4, and have a step formed partway along their length.

An enlarged diameter portion 86A is provided at a distal end portion of each protruding portion 86, and the first support pillar main body 22 is prevented from coming loose from the first circular arc portion 32 by these enlarged diameter portions 86A. Note that the enlarged diameter portions 86A may be formed by heat caulking. In other words, prior to the formation of the enlarged diameter portions 86A, the distal end portions of the protruding portions 86 are formed in a substantially circular column shape, and the distal end portions of the protruding portions 86 are inserted into the through holes 32A and are made to protrude from the first circular arc portion 32. A heat plate (not illustrated in the drawings) is then pressed from the outside against the distal end portion of the protruding portions 86, which are protruding from the first circular arc portion 32, so that the distal end portion of the protruding portions 86 is melted and takes the shape of the heat plate being pressed against it. The enlarged diameter portions 86A may be formed via this process.

In the structure of the variant example, the first circular arc portion 32 is sandwiched between the enlarged diameter portions 86A, which have been formed via the heat caulking, and a base portion of the protruding portions 86. As a result, the first support pillar main body 22 may be firmly mounted onto the first bracket 26. Moreover, because any looseness is suppressed, the accuracy of the positioning may be improved.

### Second Exemplary Embodiment

Next, a built-in support pillar 90 according to a second exemplary embodiment will be described with reference to the drawings. Note that structure that is similar to the first exemplary embodiment is described using the same symbol, and any description thereof is omitted. Furthermore, because the overall structure of the fuel tank is similar to the first exemplary embodiment illustrated in FIG. 1, no illustration or description thereof is given.

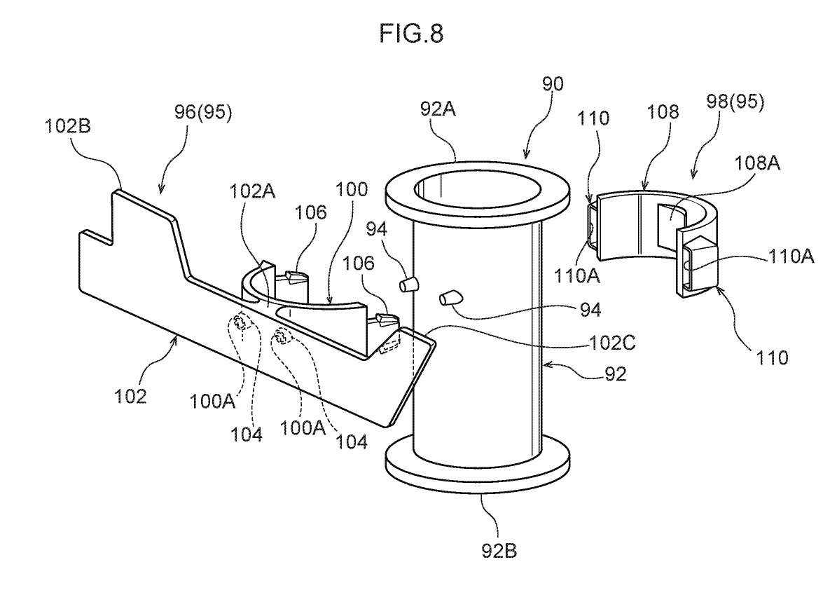

As illustrated in FIG. 8, the built-in support pillar 90 of the second exemplary embodiment includes a support pillar main body 92 and a bracket 95. The support pillar main body 92 extends in the vehicle vertical direction and joins together the bottom wall 12 and the top wall 14 which are mutually facing inner walls of the fuel tank 10 (see FIG. 1). Note that the built-in support pillar 90 of the present exemplary embodiment is provided separately from the first built-in support pillar 18 and the second built-in support pillar 20 of the first exemplary embodiment.

The support pillar main body 92 is a substantially circular cylinder-shaped component whose upper and lower end portions are open, and whose axial direction extends in the vertical direction. An upper flange 92A that extends outwards in a radial direction is provided at an upper end portion of the support pillar main body 92. The upper flange 92A is welded to the top wall 14 of the fuel tank 10. Moreover, a lower flange 92B that extends outwards in the radial direction is provided at a lower end portion of the support pillar main body 92. The lower flange 92B is welded to the bottom wall 12 of the fuel tank 10.

A pair of protruding portions 94 serving as engaging portions, which protrude from an outer circumferential surface of the support pillar main body 92, are formed slightly above a central portion in the vertical direction of the support pillar main body 92. The pair of protruding portions 94 are formed substantially in a circular column shape at a distance from each other in the circumferential direction of the support pillar main body 92, and are formed in a tapered shape such that their diameter becomes gradually smaller approaching the distal end thereof.

The bracket 95 is mounted on the support pillar main body 92. The bracket 95 is a resin component that is formed so as to be mounted on the support pillar main body 92 by sandwiching the support pillar main body 92, and is separated into two halves in the form of a half component 96 and a half component 98.

The half component 96 includes a first circular arc portion 100, and a separator 102 that serves as a built-in component. The first circular arc portion 100 is formed having a substantially circular arc-shaped cross-section so as to cover the outer circumferential surface of the support pillar main body 92 on the side thereof where the protruding portions 94 are formed. Through holes 100A serving as engaged portions that correspond to the pair of protruding portions 94 are formed in the first circular arc portion 100. The through holes 100A are formed penetrating the first circular arc portion 100 in the thickness direction thereof, and guide walls 104 protrude towards the outer side of the first circular arc portion 100 from hole edges of the respective through holes 100A.

Furthermore, claw portions 106 extend towards a second circular arc portion 108 from both end portions of the first circular arc portion 100. Distal end portions of the claw portions 106 are formed having a larger width than base end portions thereof, and by inserting these distal end portions into through holes 110A that are formed in insertion portions 110 of the second circular arc portion 108 (described below), the first circular arc portion 100 is attached to the second circular arc portion 108.

The separator 102 is an elongated plate component whose longitudinal direction extends in an orthogonal direction relative to the axial direction of the support pillar main body 92, and is formed integrally with the first circular arc portion 100. A linking portion 102A is provided protruding outwards from a surface on the first circular arc portion 100 side of the separator 102 in a central portion in the longitudinal direction thereof. The linking portion 102A is linked to a portion between the pair of through holes 100A in the first circular arc portion 100.

A first protruding portion 102B is formed protruding upwards on one end side in the longitudinal direction of the separator 102, and a second protruding portion 102C is formed protruding upwards at another end portion in the longitudinal direction of the separator 102. Additionally, plural through holes (not illustrated in the drawings) are formed in the separator 102, and fuel inside the fuel tank 10 is able to flow to an opposite side through these through holes. Flow noise inside the fuel tank 10 is suppressed by the separator 102. Note that the configuration of the separator 102 is not limited to the above-described configuration, and another configuration may be employed.

The half component 98 includes the second circular arc portion 108. The second circular arc portion 108 is formed having a substantially circular arc-shaped cross-section so as to cover the outer circumferential surface of the support pillar main body 92 on the opposite side from the first circular arc portion 100. The insertion portions 110 are provided on the outer circumferential surface of both end portions of the second circular arc portion 108.

The through holes 110A are formed in each of the insertion portions 110, and the claw portions 106 of the first circular arc portion 108 are inserted through these through holes 110A. The first circular arc portion 100 is attached to the second circular arc portion 108 when the claw portions 106 that have been inserted through the insertion portions 110 are anchored therein.

Pressing pieces 108A are formed on the second circular arc portion 108 as urging portions. A pair of left and right pressing pieces 108A are formed, and extend respectively in a cantilever arrangement from the second circular arc portion 108. Distal end portions of the pressing pieces 108A are positioned on the inner side (i.e., on the second support pillar main body 92 side) of the main portion of the second circular arc portion 108. Consequently, a structure is created in which, in a state in which the second support pillar main body 92 is sandwiched between the first circular arc portion 100 and the second circular arc portion 108, the pressing pieces 108A urge the second support pillar main body 92 towards the first circular arc portion 100 side.

[Operation and Effects]

Next, an operation and effects of the second exemplary embodiment will be described.

According to the built-in support pillar 90 of the second exemplary embodiment, the plate-shaped separator 102 is formed integrally with the bracket 95. As a result, because the separator 102 is fixed to the support pillar main body 92 via the bracket 95, the position and configuration of the separator 102 may be altered simply by replacing the bracket 95. In other words, there is a greater degree of freedom when designing the fuel tank 10.

A built-in support pillar for a fuel tank according to the first exemplary embodiment and the second exemplary embodiment has been described above, however, it is appreciated that this built-in support pillar for a fuel tank may be implemented in a variety of aspects insofar as they do not depart from the spirit or scope of the present disclosure. For example, in the above-described exemplary embodiments, a pair of protruding portions are formed as engaging portions on the support pillar main body, however, the disclosure is not limited to this and it is also possible for a pair of recessed portions to be formed as the engaging portions. In this case, projecting portions that correspond to the recessed portions may be formed on the bracket side, and these projecting portions may be used as the engaged portions.

Moreover, in the above-described exemplary embodiments, a pair of circular column-shaped protruding portions are used as the engaging portions, however, the disclosure is not limited to this, and some other configuration may be used. For example, substantially square column-shaped protruding portions may be formed as the engaging portions. It is also possible for the engaging portions to be formed by three or more protruding portions.

In the above-described exemplary embodiments, two half components obtained by separating the bracket into two halves are provided, and the bracket is mounted on the support pillar main body by sandwiching the support pillar main body between these half components, however, the disclosure is not limited to this. For example, it is also possible to employ a structure in which, in FIG. 3, the bracket is formed by only the half component 28, and in a state in which the through holes 32A in the half component 28 are engaged with the protruding portions 24, the half component 28 is attached by fastening components such as bolts or the like to the support pillar main body 22. In this case, the half component 30 becomes unnecessary.

In the above-described exemplary embodiments, the shape of the sensor fixing portion is not particularly limited, and provided that the shape enables the remaining-quantity detection sensor to be fixed thereto, some other shape may be used instead. In the same way, the shape of the pipe distal end fixing portion is not particularly limited, and provided that the shape enables the fuel suctioning unit to be fixed thereto, some other shape may be used instead.

What is claimed is:

1. A built-in support pillar for a fuel tank comprising:
a support pillar main body that is configured to be disposed inside a box-shaped fuel tank, and that joins together mutually facing internal walls of the fuel tank;
an engaging portion for positioning that is formed on an outer circumferential surface of the support pillar main body; and
a bracket that is mounted on the support pillar main body, the bracket including an engaged portion configured to be engaged with the engaging portion, and a fixing portion to which a built-in component is fixed.

2. The built-in support pillar for a fuel tank according to claim 1, wherein the engaging portion includes a pair of protruding portions or a pair of recessed portions that are formed on the outer circumferential surface of the support pillar main body, and
the bracket is mounted on the support pillar main body as a result of the engaged portion being engaged with the pair of protruding portions or the pair of recessed portions.

3. The built-in support pillar for a fuel tank according to claim 1, wherein the fixing portion is configured to fix a remaining-quantity detection sensor that detects a quantity of fuel remaining inside the fuel tank thereto.

4. The built-in support pillar for a fuel tank according to claim 1, wherein the fixing portion is configured to fix a fuel suctioning unit that is connected to a pump and suctions fuel inside the fuel tank thereto.

5. The built-in support pillar for a fuel tank according to claim 1, wherein the bracket includes a first circular arc portion and a second circular arc portion that have a circular arc-shaped cross-section, and
the bracket is mounted on the support pillar main body as a result of the support pillar main body being sandwiched between the first circular arc portion and the second circular arc portion.

6. The built-in support pillar for a fuel tank according to claim 5, wherein the engaged portion is formed on the first circular arc portion, and
the second circular arc portion includes an urging portion that is configured to, in a state in which the first circular arc portion and the second circular arc portion have been mounted on the support pillar main body, urges the support pillar main body towards the first circular arc portion side.

7. A built-in support pillar for a fuel tank comprising:
a support pillar main body that joins together mutually facing internal walls of a box-shaped fuel tank;
an engaging portion for positioning that is formed on an outer circumferential surface of the support pillar main body; and
a bracket that is mounted on the support pillar main body, the bracket including an engaged portion configured to be engaged with the engaging portion, and a plate-shaped built-in component that is configured to suppress flow noise of fuel inside the fuel tank, the plate-shaped built-in component being integrally formed with the bracket.
